(19) United States
(12) Patent Application Publication
(10) Pub. No.: US 2018/0212269 A1
(43) Pub. Date: Jul. 26, 2018

(54) NONAQUEOUS ELECTROLYTE SECONDARY BATTERY

(71) Applicant: Panasonic Intellectual Property Management Co., Ltd., Osaka-shi, Osaka (JP)

(72) Inventors: Akihiko Takada, Hyogo (JP); Fumiharu Niina, Hyogo (JP); Katsunori Yanagida, Hyogo (JP)

(73) Assignee: Panasonic Intellectual Property Management Co., Ltd., Osaka-shi, Osaka (JP)

(21) Appl. No.: 15/743,395

(22) PCT Filed: Sep. 20, 2016
(86) PCT No.: PCT/JP2016/004273

§ 371 Date: Jan. 10, 2018

(30) Foreign Application Priority Data
Sep. 29, 2015 (JP) 2015-191444

(51) Int. Cl. H01M 10/052; H01M 10/0569; H01M 10/0567; H01M 10/0587; H01M 10/04; H01M 4/66; H01M 4/131; H01M 4/485; H01M 4/50; H01M 4/52

(52) U.S. Cl. CPC H01M 10/052; H01M 10/0569; H01M 10/0567; H01M 10/0587; H01M 10/0459; H01M 2004/028; H01M 4/131; H01M 4/485; H01M 4/50; H01M 4/52; H01M 4/662

(57) ABSTRACT

It is an object of the present disclosure to provide a nonaqueous electrolyte secondary battery with improved room-temperature regeneration. The present disclosure provides a nonaqueous electrolyte secondary battery that includes an electrode assembly having a structure in which a positive plate and a negative plate are stacked with a separator therebetween and also includes a nonaqueous electrolyte. The positive plate contains a lithium transition metal oxide, an element belonging to the group 5 or 6 of the periodic table, and a phosphoric acid compound. The nonaqueous electrolyte contains 1,2-dimethoxyethane.

### TECHNICAL FIELD

The present disclosure relates to a nonaqueous electrolyte secondary battery.

### BACKGROUND ART

In recent years, smaller and lighter mobile data terminals such as mobile phones, notebook personal computers, and smartphones have been increasingly used and secondary batteries used as driving power supplies therefor have been required to have higher capacity. Nonaqueous electrolyte secondary batteries, which are charged and discharged in such a manner that lithium ions move between positive and negative electrodes, have high energy density and high capacity and therefore are widely used as power supplies for driving the mobile data terminals.

Furthermore, the nonaqueous electrolyte secondary batteries are recently attracting attention as motor power supplies for electric tools, electric vehicles (EVs), hybrid electric vehicles (HEVs and PHEVs), and the like and applications thereof are expected to be further expanded.

Such motor power supplies are required to have high capacity so as to be used for a long time or enhanced power characteristics in the case of repeating large-current charge and discharge in a relatively short time. It is essential that power characteristics during large-current charge/discharge are maintained and high capacity is achieved.

Patent Literature 1 describes that, in an electrochemical cell, using 1,2-dimethoxyethane in an electrolyte solution allows low-temperature characteristics to be enhanced, the electrical conductivity of the electrolyte solution to be increased, and a large charge-discharge capacity to be obtained.

Patent Literature 2 describes that using an electrode containing inorganic particles (Li₃PO₄ or the like) having lithium ion transfer ability suppresses the reaction of an electrode active material with an electrolyte solution on a surface of the electrode to increase safety during overcharge.

### CITATION LIST

### Patent Literature

PTL 1: Japanese Published Unexamined Patent Application No. 2015-26531
PTL 2: International Publication No. WO 2006/019245

### SUMMARY OF INVENTION

However, in the above conventional techniques, room-temperature regeneration is insufficient in some cases.

It is an object of the present disclosure to provide a nonaqueous electrolyte secondary battery with improved room-temperature regeneration.

The present disclosure provides a nonaqueous electrolyte secondary battery that includes an electrode assembly having a structure in which a positive plate and a negative plate are stacked with a separator therebetween and also includes a nonaqueous electrolyte. The positive plate contains a lithium transition metal oxide, an element belonging to the group 5 or 6 of the periodic table, and a phosphoric acid compound. The nonaqueous electrolyte contains 1,2-dimethoxyethane. The term “group 5/6 element” as used herein refers to an “element belonging to the group 5 or 6 of the periodic table”.

According to the present disclosure, a nonaqueous electrolyte secondary battery with improved room-temperature regeneration characteristics can be provided.

### BRIEF DESCRIPTION OF DRAWINGS

FIG. 1 is a schematic illustration showing an example of this embodiment.

FIG. 2 is a schematic illustration showing a conventional technique.

### DESCRIPTION OF EMBODIMENTS

As a result of intensive investigations, the inventors have found that when a positive plate contains a lithium transition metal oxide, a group 5/6 element, and a phosphoric acid compound and a nonaqueous electrolyte contains 1,2-dimethoxyethane, the group 5/6 element dissolved from the positive plate and movable decomposition products formed by the oxidative decomposition of 1,2-dimethoxyethane on a surface of the positive plate form a low-resistance coating on a surface of a negative plate to significantly improve the room-temperature regeneration of a nonaqueous electrolyte secondary battery.

An embodiment of the present disclosure is described below. This embodiment is an example. The present disclosure is not limited to embodiments below.

<Configuration of Nonaqueous Electrolyte Secondary Battery>

A nonaqueous electrolyte secondary battery according to this embodiment has substantially the same basic configuration as that of a conventional one and includes a wound electrode assembly in which a positive plate and a negative plate are stacked and wound with a separator therebetween and a nonaqueous electrolyte. The outermost peripheral surface of the wound electrode assembly is covered by the separator. The nonaqueous electrolyte secondary battery according to this embodiment is not limited to the above configuration and may include the wound electrode assembly, in which the positive plate and a negative plate are stacked with the separator therebetween, and the nonaqueous electrolyte.

The positive plate (hereinafter also referred to as the “positive electrode”) includes a positive core and positive electrode mix layers placed on both surfaces of the positive core. The positive electrode mix layers are placed such that positive core-exposed portions where the positive core is narrowly exposed at at least one of lateral end portions along a longitudinal direction are located on both surfaces of the positive core.

The negative plate (hereinafter also referred to as the “negative electrode”) includes a negative core and negative electrode mix layers placed on both surfaces of the negative core. The negative electrode mix layers are placed such that negative core-exposed portions where the negative core is narrowly exposed at at least one of lateral end portions along a longitudinal direction are located on both surfaces of the negative core.

The wound electrode assembly is flat or cylindrical and is prepared in such a manner that the positive plate and the negative plate are wound with the separator therebetween and are formed into, for example, a flat or cylindrical shape. In this operation, the wound positive core-exposed portions are formed at one of end portions of the wound electrode assembly and the wound negative core-exposed portions are formed at the other end portion.

The wound positive core-exposed portions are electrically connected to a positive electrode terminal through a positive electrode current collector. On the other hand, the wound negative core-exposed portions are electrically connected to a negative electrode terminal through a negative electrode current collector. The positive electrode terminal is fixed to a sealing body through an insulating member. The negative plate is also fixed to the sealing body through the insulating member.

The wound electrode assembly is housed in a prismatic or cylindrical enclosure in such a state that the wound electrode assembly is covered by an insulating sheet made of resin. The sealing body is brought into contact with an opening of the enclosure, which is made of metal, and a contact between the sealing body and the enclosure is laser-welded.

The sealing body has an electrolyte solution inlet. A nonaqueous electrolyte solution is poured from the electrolyte solution inlet. Thereafter, the electrolyte solution inlet is sealed with a blind rivet or the like. Of course, the nonaqueous electrolyte secondary battery is an example, may have another configuration, and may be, for example, a laminate-type nonaqueous electrolyte secondary battery formed by providing the nonaqueous electrolyte solution and the wound electrode assembly in a laminate enclosure.

The positive plate, the negative plate, the nonaqueous electrolyte, the negative plate, and the separator in the nonaqueous electrolyte secondary battery according to this embodiment are described below.

<Positive Plate>

The positive electrode is composed of, for example, the positive core, such as metal foil, and the positive electrode mix layers, which are placed on the positive core. The positive core used may be foil of a metal stable in the potential range of the positive electrode; a film including a surface layer containing the metal; or the like. Metal contained in the positive core is preferably aluminium or an aluminium alloy. The positive electrode current collector and the positive electrode terminal are preferably made of aluminium or the aluminium alloy.

The positive electrode mix layers contain a lithium transition metal oxide that is a positive electrode active material, a group 5/6 element, and a phosphoric acid compound. The positive electrode mix layers preferably further contain a conductive agent and a binding agent. The positive plate can be prepared in such a manner that, for example, positive electrode mix slurry containing the positive electrode active material, the binding agent, and the like is applied to the positive core, wet coatings are dried and are then rolled, and the positive electrode mix layers are thereby formed on both surfaces of the positive core.

In the nonaqueous electrolyte secondary battery according to this embodiment, the group 5/6 element may be contained in any state as long as the group 5/6 element is present near the lithium transition metal oxide in the positive electrode mix layers. For example, a compound of the group 5/6 element may be attached to the surfaces of particles of the lithium transition metal oxide. Alternatively, the group 5/6 element may be contained in the lithium transition metal oxide. In particular, the group 5/6 element is preferably contained in the lithium transition metal oxide. This is because the group 5/6 element has a property that the ease of dissolving the group 5/6 element and the rate of incorporating the group 5/6 element in a coating due to decomposition products derived from DME are optimum and the group 5/6 element is likely to form a low-resistance coating.

[Lithium Transition Metal Oxide]

The lithium transition metal oxide, which is contained in the positive electrode as a positive electrode active material, is a metal oxide containing lithium (Li) and a transition metal element. The lithium transition metal oxide may contain an additive element in addition to lithium (Li) and the transition metal element.

The lithium transition metal oxide can be represented by, for example, the formula LiₓMe_{y}O₂. In the above formula, Me is one or more transition metal elements including at least one selected from the group consisting of nickel (Ni), cobalt (Co), and manganese (Mn); x is, for example, 0.8 to 1.2; and y varies depending on the type and oxidation number of Me and is, for example, 0.7 to 1.3. The lithium transition metal oxide is particularly preferably lithium nickel-cobalt-manganate, which contains Ni, Co, and Mn as transition metals.

Examples of the additive element, which may be contained in the lithium transition metal oxide, include alkali metal elements other than lithium; transition metal elements other than Mn, Ni, and Co; alkaline-earth metal elements; group 12 elements; group 13 elements; and group 14 elements. Particular examples of transition metal elements which may be contained in the lithium transition metal oxide and which are other than Ni, Co, Mn, and the group 5/6 element and the additive element include zirconium (Zr), boron (B), magnesium (Mg), aluminium (Al), titanium (Ti), iron (Fe), copper (Cu), zinc (Zn), tin (Sn), sodium (Na), potassium (K), barium (Ba), strontium (Sr), and calcium (Ca).

The lithium transition metal oxide preferably contains Zr as a transition metal. This is because Zr contained therein varies the amount of decomposed 1,2-dimethoxyethane (DME) contained in the nonaqueous electrolyte and the amount of the decomposition products can be adjusted. The content of Zr in the lithium transition metal oxide is preferably 0.05% by mole to 10% by mole, more preferably 0.1% by mole to 5% by mole, and particularly preferably 0.2% by mole to 3% by mole with respect to the amount of metal except Li. It is conceivable that when the content of Zr is as described above, the amount of decomposed DME is adjusted, the crystal structure of the lithium transition metal oxide is stabilized, and the high-temperature durability and cycle properties of the positive electrode mix layers are enhanced.

In the nonaqueous electrolyte secondary battery according to this embodiment, the particle size of the lithium transition metal oxide is not particularly limited and is preferably 2 μm to 30 μm. When particles of the lithium transition metal oxide are secondary particles formed by the aggregation of primary particles, the secondary particles preferably have the above size and the primary particles have a size of, for example, 50 nm to 10 μm. The particle size of the lithium transition metal oxide may be a value that is determined in such a manner that, for example, 100 of the lithium transition metal oxide particles observed with a scanning electron microscope (SEM) are extracted at random, the average of the lengths of the major and minor axes of each particle is set to the size of the particle, and the sizes of the 100 particles are averaged. The BET specific surface area of the lithium transition metal oxide is not particularly limited and is preferably 0.1 m²/g to 6 m²/g. The BET specific surface area of the lithium transition metal oxide can be measured with a known BET specific surface area analyzer.

[Group 5/6 Element]

In the nonaqueous electrolyte secondary battery according to this embodiment, the positive electrode mix layers of the positive plate contain the group 5/6 element. Elements belonging to the group 5 of the periodic table are vanadium (V), niobium (Nb), tantalum (Ta), and dubnium (Db). Elements belonging to the group 6 of the periodic table are chromium (Cr), molybdenum (Mo), tungsten (W), and seaborgium (Sg).

Although the group 5/6 element is contained in the positive electrode mix layers of the positive plate during manufacture, the group 5/6 element is dissolved in the nonaqueous electrolyte during the charge of the nonaqueous electrolyte secondary battery to migrate to the negative electrode and forms a coating on a surface of the negative electrode together with the decomposition products of 1,2-dimethoxyethane (DME) oxidatively decomposed on a surface of the positive electrode during the charge thereof. Since the phosphoric acid compound is contained in the positive electrode mix layers, the group 5/6 element and the decomposition products derived from DME form a low-resistance coating. The group 5/6 element has a common property that the group 5/6 element is dissolved during charge or discharge and is incorporated in a coating due to the decomposition products derived from DME to form the low-resistance coating. Therefore, it is conceivable that the group 5/6 element forms the low-resistance coating on the negative electrode surface in the presence of the phosphoric acid compound in the positive electrode mix layers.

The group 5/6 element, which is contained in the positive plate of the nonaqueous electrolyte secondary battery according to this embodiment, is preferably W, Nb, Ta, Cr, or Mo and is particularly preferably tungsten. This is because tungsten has a property that the ease of dissolving tungsten and the rate of incorporating tungsten in the coating due to the decomposition products derived from DME are optimum and tungsten is likely to form the low-resistance coating. In the case where the group 5/6 element compound is attached to the surfaces of the lithium transition metal oxide particles, examples of the group 5/6 element compound include tungsten oxides such as WO₃ and W₂O₅ and tungsten oxide salts such as lithium tungstate. Among the tungsten oxides, WO₃, in which the oxidation number is hexavalent and which is most stable, is preferable.

The group 5/6 element compound can be attached to the surfaces of the active material particles by, for example, mechanically mixing the group 5/6 element with the positive electrode active material. Alternatively, the group 5/6 element compound may be mixed in the positive electrode mix layers by adding the group 5/6 element compound in a step of preparing positive electrode mix slurry by kneading the conductive agent and the binding agent. The group 5/6 element compound is preferably added to the positive electrode mix layers by the former method. This allows the group 5/6 element compound to be efficiently present near the surfaces of the active material particles.

The content of the group 5/6 element in the positive plate in the case of attaching the group 5/6 element to the lithium transition metal oxide is preferably such a value that the amount of the group 5 or 6 element is 0.05% by mole to 10% by mole of the amount of metals (that is, a transition metal and the additive element) excluding Li in the lithium transition metal oxide, more preferably 0.1% by mole to 5% by mole, and particularly preferably 0.2% by mole to 3% by mole. When the content of the group 5/6 element is within this range, the formation of the low-resistance coating due to the decomposition products of 1,2-dimethoxyethane on the negative electrode surface is further accelerated.

The particle size of the group 5/6 element attached to the lithium transition metal oxide is preferably less than the particle size of the lithium transition metal oxide and is particularly preferably 25% or less of the particle size of the oxide. The particle size of the group 5/6 element is, for example, 50 nm to 10 μm. When the particle size thereof is within this range, it is conceivable that the dispersion of the group 5/6 element in the positive electrode mix layers is maintained good and the dissolution of the group 5/6 element from the positive plate is preferable.

The particle size of the group 5/6 element, as well as the lithium transition metal oxide, is a value that is determined in such a manner that, for example, 100 of particles of the group 5/6 element observed with a scanning electron microscope (SEM) are extracted at random, the average of the lengths of the major and minor axes of each particle is set to the size of the particle, and the sizes of the 100 particles are averaged. When the group 5/6 element is present in the form of aggregates, the particle size of the group 5/6 element is the size of particles (primary particles) that are the minimum units forming aggregates.

On the other hand, the group 5/6 element may be contained in the lithium transition metal oxide. The lithium transition metal oxide containing the group 5/6 element has a common property that the lithium transition metal oxide containing the group 5/6 element is dissolved during charge or discharge and is incorporated in the coating due to the decomposition products derived from DME to form the low-resistance coating and therefore is preferable. The lithium transition metal oxide containing the group 5/6 element can be synthesized in such a manner that, for example, a composite oxide containing Ni, Co, Mn, or the like, a lithium compound such as lithium hydroxide, and an oxide of the group 5/6 element are mixed together and the obtained mixture is fired. The lithium transition metal oxide obtained in this manner corresponds to one represented by the formula LiₓMe_{y}O₂, where Me includes the group 5/6 element in addition to at least one selected from the group consisting of nickel (Ni), cobalt (Co), and manganese (Mn).

When the lithium transition metal oxide contains the group 5/6 element, the lithium transition metal oxide and the group 5/6 element are preferably present in the form of a solid solution. The group 5/6 element may be partially precipitated at the interfaces between primary particles of the positive electrode active material or on the surfaces of secondary particles thereof. The lithium transition metal oxide containing the group 5/6 element is particularly preferably a lithium transition metal oxide containing Ni, Co, Mn, and W as transition metals.

When the lithium transition metal oxide contains the group 5/6 element, the content of the group 5/6 element therein is preferably such a value that the amount of the group 5/6 element is 0.05% by mole to 10% by mole of the amount of metals (that is, a transition metal and the additive element) excluding Li in the lithium transition metal oxide and more preferably 0.1% by mole to 5% by mole. When the content of the group 5/6 element therein is within this range, the formation of the low-resistance coating due to the decomposition products of 1,2-dimethoxyethane on the negative electrode surface is further accelerated.

[Phosphoric Acid Compound]

In the nonaqueous electrolyte secondary battery according to this embodiment, the positive electrode mix layers of the positive plate contain the phosphoric acid compound. The phosphoric acid compound, which is mixed in the positive electrode mix layers, is not particularly limited. Examples of the phosphoric acid compound include phosphoric acid and phosphates such as lithium phosphate, lithium dihydrogen phosphate, cobalt phosphate, nickel phosphate, manganese phosphate, potassium phosphate, and ammonium dihydrogen phosphate. Among these compounds, lithium phosphate is particularly preferable.

In the nonaqueous electrolyte secondary battery according to this embodiment, the group 5/6 element dissolved from the positive electrode mix layers during the charge thereof and the decomposition products of DME oxidatively decomposed on the positive electrode surface migrate to the negative electrode surface and are reduced, whereby a coating composed of a mixture of the group 5/6 element and the decomposition products derived from DME is formed. When the phosphoric acid compound is contained in the positive electrode mix layers, the dissolution behavior of the group 5/6 element and the decomposition rate of DME on the positive electrode are varied by the catalysis of the phosphoric acid compound. As a result, it is conceivable that a coating with lower resistance is formed and room-temperature regeneration is more significantly improved by the variation of the composition of a coating formed on the negative electrode as compared to the case where the phosphoric acid compound is not present in the positive electrode mix layers.

The content of the phosphoric acid compound in the positive electrode mix layers is preferably 0.03% by mass to 10% by mass and more preferably 0.1% by mass to 8% by mass with respect to the amount of the lithium transition metal oxide, which is the positive electrode active material. The content thereof is preferably 0.01% by mass to 3% by mass and more preferably 0.03% by mass to 2% by mass with respect to the amount of the lithium transition metal oxide in terms of phosphorus (P) element. When the content of the phosphoric acid compound is too small, no low-resistance coating may possibly be sufficiently formed. When the content of the phosphoric acid compound is too large, the efficient transfer of electrons in the positive electrode active material may possibly be inhibited.

The particle size of the phosphoric acid compound is preferably less than the particle size of the lithium transition metal oxide and is particularly preferably 25% or less of the particle size of the oxide. The particle size of the phosphoric acid compound is, for example, 50 nm to 10 μm. When the particle size thereof is within this range, the dispersion of the phosphoric acid compound in the positive electrode mix layers is maintained good. The particle size of the phosphoric acid compound, as well as the lithium transition metal oxide, is a value that is determined in such a manner that 100 of particles of the phosphoric acid compound observed with a scanning electron microscope (SEM) are extracted at random, the average of the lengths of the major and minor axes of each particle is set to the size of the particle, and the sizes of the 100 particles are averaged. When the phosphoric acid compound is present in the form of aggregates, the particle size of the phosphoric acid compound is the size of particles (primary particles) that are the minimum units forming aggregates.

The phosphoric acid compound can be attached to the surfaces of the active material particles by, for example, mechanically mixing the phosphoric acid compound with the positive electrode active material. Alternatively, the phosphoric acid compound may be mixed in the positive electrode mix layers by adding the phosphoric acid compound in the step of preparing the positive electrode mix slurry by kneading the conductive agent and the binding agent. The phosphoric acid compound is preferably added to the positive electrode mix layers by the former method. This allows the phosphoric acid compound to be efficiently present near the surfaces of the active material particles.

[Conductive Agent]

The conductive agent is used to increase the electrical conductivity of the positive electrode mix layers. Examples of the conductive agent include carbon materials such as carbon black, acetylene black, Ketjenblack, and graphite. These materials may be used alone or in combination.

[Binding Agent]

The binding agent is used to maintain the good contact between the positive electrode active material and the conductive agent and to increase the adhesion of the positive electrode active material and the like to a surface of the positive electrode core. Examples of the binding agent include fluorinated resins such as polytetrafluoroethylene (PTFE) and polyvinylidene fluoride (PVdF), polyacrylonitrile (PAN), polyimide resins, acrylic resins, and polyolefinic resins. These resins may be used in combination with carboxymethylcellulose (CMC), a salt thereof (that may be CMC-Na, CMC-K, CMC-NH₄, a partially neutralized salt, or the like), polyethylene oxide (PEO), or the like. These materials may be used alone or in combination.

<Nonaqueous Electrolyte>

The nonaqueous electrolyte contains a nonaqueous solvent and an electrolyte salt dissolved in the nonaqueous solvent. The nonaqueous solvent contains 1,2-dimethoxyethane (DME). In the nonaqueous electrolyte secondary battery, since the nonaqueous electrolyte contains DME, room-temperature regeneration characteristics of the nonaqueous electrolyte secondary battery can be improved on condition that the positive electrode contains the phosphoric acid compound and the group 5/6 element. This is probably because, in the nonaqueous electrolyte secondary battery according to this embodiment, the decomposition products derived from DME decomposed on the positive electrode and the group 5/6 element dissolved from the positive electrode form the low-resistance coating on the negative electrode surface.

The nonaqueous electrolyte may contain a nonaqueous solvent other than DME. Examples of the nonaqueous solvent other than DME include esters, ethers, nitriles, amides such as dimethylformamide, mixtures of two or more of these solvents, and halogen-substituted compounds obtained by substituting at least one hydrogen atom in these solvents with an atom of a halogen such as fluorine.

The content of DME in the nonaqueous electrolyte is preferably 3% by volume to 20% by volume with respect to the amount of a solvent contained in the nonaqueous electrolyte. This is because when the content of DME therein is too small, the effect of forming a coating is not sufficiently exhibited in some cases and when the content of DME therein is too large, DME is cointegrated in the negative electrode and therefore battery characteristics are reduced in some cases.

Cyclic carbonates, linear carbonates, and carboxylates can be exemplified as esters contained in the nonaqueous electrolyte. Examples of the esters include cyclic carbonates such as ethylene carbonate (EC), propylene carbonate (PC), butylene carbonate, and vinylene carbonate; linear carbonates such as dimethyl carbonate (DMC), ethyl methyl carbonate (EMC), diethyl carbonate (DEC), methyl propyl carbonate, ethyl propyl carbonate, and methyl isopropyl carbonate; linear carboxylates such as methyl propionate (MP), ethyl propionate, methyl acetate, ethyl acetate, and propyl acetate; and cyclic carboxylates such as γ-butyrolactone (GBL) and γ-valerolactone (GVL). Cyclic carboxylates such as γ-butyrolactone (GBL) and γ-valerolactone (GVL) are cited.

Examples of ethers contained in the nonaqueous electrolyte include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol, and crown ethers and linear ethers such as diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl.

Examples of nitriles contained in the nonaqueous electrolyte include acetonitrile, propionitrile, butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile.

Examples of a halogen-substituted compound contained in the nonaqueous electrolyte include fluorinated cyclic carbonates such as 4-fluoroethylene carbonate (FEC), fluorinated linear carbonates, and fluorinated linear carboxylates such as methyl 3,3,3-trifluoropropionate (FMP).

In the nonaqueous electrolyte solution according to this embodiment, the nonaqueous electrolyte preferably contains a solvent mixture of DME and the above esters and more preferably a solvent mixture of DME, the cyclic carbonates, the linear carbonates, and the linear carboxylates. This solvent mixture particularly preferably contains the cyclic carbonates, the linear carbonates, the linear carboxylates, and DME at a volume ratio of 10:10:1:3 to 50:80:20:20.

The electrolyte salt, which is used in the nonaqueous electrolyte, is preferably a lithium salt. Examples of the lithium salt include LiBF₄; LiClO₄; LiPF₆; LiAsF₆; LiSbF; LiAlCl₄; LiSCN; LiCF₃SO₃; LiC(C₂F₅SO₂); LiCF₃CO₂; Li(P(C₂O₄)F₄); Li(P(C₂O₄)F₂); LiPF₆₋ₓ(CF₂ₙ₊₁). (where 1≤x≤6 and n is 1 or 2); LiB₁₀Cl₁₀; LiCl; LiBr; LiI; chloroborane lithium; lithium lower aliphatic carboxylates; borates such as Li₂B₄O₇, Li(B(C₂O₄)₂) [lithium-bisoxalate borate (LiBOB)], and Li(B(C₂O₄)F₂); and imide salts such as LiN(FSO₂)₂ and LiN(CₗF₂ₗ₊₁SO₂)(CₘF₂ₘ₊₁SO₂) {where l and m are integers greater than or equal to i}. The lithium salt used may be one of these salts or a mixture of some of these salts. Among these salts, at least one fluorine-containing lithium salt is preferably used from the viewpoint of ionic conductivity, electrochemical stability, and the like. For example, LiPFe is preferably used. In particular, in order to form a coating stable in a high-temperature environment the negative electrode surface and in order to suppress the formation of excessive coatings due to the decomposition products of DME, the fluorine-containing lithium salt and a lithium salt containing oxalato complex anions (for example, LiBOB) are preferably used in combination. The concentration of the lithium salt is preferably 0.8 mol to 1.8 mol per liter of the nonaqueous solvent.

<Negative Plate>

The negative plate used may be a known negative plate. The negative plate can be prepared in such a manner that, for example, negative electrode mix slurry is prepared by dispersing a negative electrode active material and a binding agent in water or an appropriate dispersion medium and is applied to the negative electrode current collector, wet coatings are dried and are then rolled, and negative electrode mix layers are thereby formed on both surfaces of the negative electrode core. The negative electrode core used is preferably a conductive thin film, particularly foil of a metal stable in the potential range of the negative electrode, a film including a surface layer containing the metal, or the like. Metal contained in the negative electrode core is preferably copper or a copper alloy. The negative electrode current collector and the negative electrode terminal are preferably made of copper or the copper alloy.

The negative electrode active material is not particularly limited and may be capable of reversely storing and releasing lithium ions. The negative electrode active material used may be a carbon material such as natural graphite or synthetic graphite; a metal, such as Si or Sn, alloyed with lithium; an alloy material; a metal composite oxide; or the like. These may be used alone or in combination. In particular, a carbon material obtained by coating a graphite material with low-crystallinity carbon is preferably used because the low-resistance coating is likely to be formed on the negative electrode surface.

[Binding Agent]

The binding agent used may be a known binding agent. As is the case with the positive electrode, the binding agent used may be a fluorinated resin such as PTFE, PAN, a polyimide resin, an acrylic resin, a polyolefinic resin, or the like. In the case of using an aqueous solvent to prepare the negative electrode mix slurry, the following material is preferably used: CMC, a salt thereof, styrene-butadiene rubber (SBR), polyacrylic acid (PAA), a salt thereof (that may be PAA-Na, PAA-K, a partially neutralized salt, or the like), polyvinyl alcohol (PVA), or the like. The binding agent used to prepare the negative plate is particularly preferably a combination of CMC or a salt thereof and a styrene-butadiene copolymer (SBR) or a modification thereof.

<Separator>

The separator used is a porous sheet having ionic permeability and insulation properties. Examples of the porous sheet include microporous thin films, fabrics, and nonwoven fabrics. The separator is preferably made of an olefinic resin such as polyethylene or polypropylene, cellulose, or the like. The separator may be a laminate including a cellulose fiber layer and a thermoplastic resin fiber layer made of the olefinic resin or the like. Alternatively, the separator may be a multilayer separator including a polyethylene layer and a polypropylene layer or a separator having a surface coated with an aramid resin or the like.

### EXAMPLES

The present disclosure is further described below in detail with reference to examples and comparative examples. The present disclosure is not limited to the examples.

### Experiment Example 1

[Preparation of Positive Electrode Active Material]

A nickel-cobalt-manganese composite oxide was prepared by firing a nickel-cobalt-manganese composite hydroxide that was obtained in such a manner that NiSO₄, CoSO₄, and MnSO₄ were mixed in an aqueous solution and were co-precipitated. Next, the composite oxide, lithium carbonate, tungsten oxide (WO₃), and zirconium oxide (ZrO₂) were mixed using a Raikai mortar. In the mixture, the mixing ratio (molar ratio) of lithium to a combination of nickel, cobalt, and manganese that were transition metals to tungsten to zirconium was 1.15:1.0:0.005:0.005. The mixture was fired at 900° C. for 10 hours in air, followed by grinding, whereby a lithium transition metal oxide (positive electrode active material) containing W and Zr was obtained. The obtained positive electrode active material was subjected to elemental analysis by ICP emission spectrometry, resulting in that the molar ratio of Ni, Co, M, W, and Zr to the total of the transition metals was 46.7, 26.7, 25.6, 0.5, and 0.5, respectively.

Next, the obtained lithium transition metal oxide was mixed with 0.5% by mole of WO₃ with respect to the amount of metal elements (transition metals) excluding Li in the oxide and 5% by mass of lithium phosphate (Li₃PO₄) with respect to the amount of the oxide, whereby a positive electrode active material having WO₃ and Li₃PO₄ attached to the surfaces of particles thereof was obtained.

[Preparation of Positive Electrode]

The positive electrode active material, carbon black, and polyvinylidene fluoride (PVDF) were mixed at a mass ratio of 91:7:2. To the mixture, N-methyl-2-pyrrolidone (NMP) serving as a dispersion medium was added, followed by kneading, whereby positive electrode mix slurry was prepared. Next, the positive electrode mix slurry was applied to aluminium foil that was a positive electrode current collector and a wet coating was dried, whereby a positive electrode mix layer was formed on the aluminium foil. The positive electrode current collector provided with the positive electrode mix layer was cut to a predetermined size, followed by rolling and attaching an aluminium tab thereto, whereby a positive electrode was obtained.

The positive electrode obtained as described above was observed with a scanning electron microscope (SEM), whereby it was confirmed that tungsten oxide particles with an average size of 150 nm and lithium phosphate particles with an average size of 100 nm were attached to the surface of the lithium transition metal composite oxide. Incidentally, tungsten oxide and lithium phosphate are partially detached from the surface of the positive electrode active material in some cases. Therefore, portions of tungsten oxide and lithium phosphate are contained in the positive electrode without being attached to the positive electrode active material particles in some cases. Observation with the SEM confirmed that lithium phosphate was attached to tungsten oxide or was present near tungsten oxide.

[Preparation of Negative Electrode]

A graphite powder, carboxymethylcellulose (CMC), and styrene-butadiene rubber (SBR) were mixed at a mass ratio of 98:1:1, followed by adding water. This was stirred using a mixer (T.K. HIVIS MIX, manufactured by PRIMIX Corporation), whereby negative electrode mix slurry was prepared. Next, the negative electrode mix slurry was applied to copper foil that was a negative electrode current collector and wet coatings were dried, followed by rolling using a rolling roller. In this way, a negative electrode including negative electrode mix layers formed on both surfaces of the copper foil was prepared.

[Preparation of Nonaqueous Electrolyte]

Ethylene carbonate (EC), methyl ethyl carbonate (MEC), dimethyl carbonate (DMC), methyl propionate (MP), and 1,2-dimethoxyethane (DME) were mixed at a volume ratio of 30:15:40:5:10. In the solvent mixture, LiPF₆ was dissolved so as to give a concentration of 1.2 mol/L. Furthermore, vinylene carbonate and LiBOB (Li(B(C₂O₄)₂)) were dissolved in the LiPF₆-containing solvent mixture so as to give a concentration of 0.3% by mass and a concentration of 0.05 mol/L, respectively.

[Preparation of Battery]

An aluminium lead was attached to the positive electrode. A nickel lead was attached to the negative electrode. A microporous membrane made of polyethylene was used as a separator. The positive electrode and the negative electrode were spirally wound with the separator therebetween, whereby a wound electrode assembly was prepared. The electrode assembly was housed in a battery case body with a bottomed cylindrical shape. After the nonaqueous electrolyte was poured into the battery case body, an opening of the battery case body was sealed with a gasket and a sealing body, whereby a cylindrical nonaqueous electrolyte secondary battery (Battery A1) was prepared.

### Experiment Example 2

A cylindrical nonaqueous electrolyte secondary battery (Battery A2) was prepared in substantially the same manner as that used in Experiment Example 1 except that the amount of lithium phosphate mixed with a lithium transition metal oxide was set to 2% by mass of the amount of the oxide in a step of preparing a positive electrode active material and a solvent mixture with an EC-to-MEC-to-DMC-to-MP-to-DME volume ratio of 30:20:40:5:5 was prepared in a step of preparing a nonaqueous electrolyte.

### Experiment Example 3

A cylindrical nonaqueous electrolyte secondary battery (Battery A3) was prepared in substantially the same manner as that used in Experiment Example 2 except that a solvent mixture with an EC-to-MEC-to-DMC-to-MP-to-DME volume ratio of 30:10:40:5:15 was prepared in a step of preparing a nonaqueous electrolyte.

### Experiment Example 4

A cylindrical nonaqueous electrolyte secondary battery (Battery A4) was prepared in substantially the same manner as that used in Experiment Example 2 except that a solvent mixture with an EC-to-MEC-to-DMC-to-MP-to-DME volume ratio of 30:5:40:5:20 was prepared in a step of preparing a nonaqueous electrolyte.

### Experiment Example 5

A cylindrical nonaqueous electrolyte secondary battery (Battery A5) was prepared in substantially the same manner as that used in Experiment Example 2 except that a solvent mixture with an EC-to-DMC-to-MP-to-DME volume ratio of 30:35:5:30 was prepared in a step of preparing a nonaqueous electrolyte.

### Experiment Example 6

A cylindrical nonaqueous electrolyte secondary battery (Battery A6) was prepared in substantially the same manner as that used in Experiment Example 2 except that a nickel-cobalt-manganese composite oxide, lithium carbonate, and zirconium oxide only were mixed together using a Raikai mortar in a step of preparing a positive electrode active material.

### Experiment Example 7

A cylindrical nonaqueous electrolyte secondary battery (Battery A7) was prepared in substantially the same manner as that used in Experiment Example 2 except that no tungsten oxide was mixed with a lithium transition metal oxide in a step of preparing a positive electrode active material.

### Experiment Example 8

A cylindrical nonaqueous electrolyte secondary battery (Battery A8) was prepared in substantially the same manner as that used in Experiment Example 2 except that a nickel-cobalt-manganese composite oxide, lithium carbonate, and zirconium oxide only were mixed together using a Raikai mortar and a lithium transition metal oxide containing no tungsten was prepared in a step of preparing a positive electrode active material and a solvent mixture with an EC-to-MEC-to-DMC-to-MP volume ratio of 30:25:40:5 was prepared in a step of preparing a nonaqueous electrolyte.

### Experiment Example 9

A cylindrical nonaqueous electrolyte secondary battery (Battery A9) was prepared in substantially the same manner as that used in Experiment Example 6 except that no lithium phosphate was mixed with a lithium transition metal oxide in a step of preparing a positive electrode active material.

### Experiment Example 10

A cylindrical nonaqueous electrolyte secondary battery (Battery A10) was prepared in substantially the same manner as that used in Experiment Example 1 except that a nickel-cobalt-manganese composite oxide, lithium carbonate, and zirconium oxide only were mixed together using a Raikai mortar, a lithium transition metal oxide containing no tungsten was prepared, and no lithium phosphate was mixed with the lithium transition metal oxide in a step of preparing a positive electrode active material.

### Experiment Example 11

A cylindrical nonaqueous electrolyte secondary battery (Battery A11) was prepared in substantially the same manner as that used in Experiment Example 1 except that no lithium phosphate was mixed with a lithium transition metal oxide in a step of preparing a positive electrode active material and a solvent mixture with an EC-to-MEC-to-DMC-to-MP volume ratio of 30:25:40:5 was prepared in a step of preparing a nonaqueous electrolyte.

### Experiment Example 12

A cylindrical nonaqueous electrolyte secondary battery (Battery A12) was prepared in substantially the same manner as that used in Experiment Example 1 except that no lithium phosphate was mixed with a lithium transition metal oxide in a step of preparing a positive electrode active material.

### Experiment Example 13

A cylindrical nonaqueous electrolyte secondary battery (Battery A13) was prepared in substantially the same manner as that used in Experiment Example 1 except that the amount of lithium phosphate mixed with a lithium transition metal oxide was set to 2% by mass of the amount of the oxide in a step of preparing a positive electrode active material and a solvent mixture with an EC-to-MEC-to-DMC-to-MP volume ratio of 30:25:40:5 was prepared in a step of preparing a nonaqueous electrolyte.

[Power Characteristic Test]

Constant-current charge was performed using Batteries A1 to A13, which were prepared as described above, with a current of 800 mA under 25° C. temperature conditions until the voltage reached 4.1 V. Next, constant-voltage charge was performed with a voltage of 4.1 V until the current reached 0.1 mA. Thereafter, constant-current discharge was performed with a current of 800 mA until the voltage reached 2.5 V. The discharge capacity determined by the constant-current discharge was defined as the rated capacity of each secondary battery.

Next, constant-current discharge was performed with a current of 800 mA at a battery temperature of 25° C. until the voltage reached 2.5 V. Charge was performed again until 50% of the rated capacity was achieved. Thereafter, the room-temperature regeneration value of each secondary battery at a state of charge (SOC) of 50% was determined by an equation below from the maximum current at which charge can be performed for 10 seconds when the charge cut-off voltage is 4.3 V.

Room-temperature regeneration value (SOC of 50%)=(measured maximum current)×charge cut-off voltage (4.3 V)

The proportion of the room-temperature regeneration characteristic of each of Batteries A1 to A13 was calculated on the basis of the regeneration characteristic result of Battery A9 of Experiment Example 7. The results are shown in Table 1.

TABLE 1

| | Positive | | | | | |
|---|---|---|---|---|---|---|
| | Electrode | | Positive | | | |
| | Active Material | | Electrode Mix | | | Room- |
| | Zr | W | Layer | | | temperature |
| Battery | content | content | LPO | WO₃ | DME | Regeneration |
| Number | (mol %) | (mol %) | (mass %) | (mol %) | (vol %) | (%) |
| A1 | 0.5 | 0.5 | 2 | 0.5 | 10 | 108 |
| A2 | 0.5 | 0.5 | 2 | 0.5 | 5 | 108 |
| A3 | 0.5 | 0.5 | 2 | 0.5 | 15 | 114 |
| A4 | 0.5 | 0.5 | 2 | 0.5 | 20 | 106 |
| A5 | 0.5 | 0.5 | 2 | 0.5 | 30 | 104 |
| A6 | 0.5 | 0 | 2 | 0.5 | 5 | 103 |
| A7 | 0.5 | 0.5 | 2 | 0 | 5 | 103 |
| A8 | 0.5 | 0 | 2 | 0.5 | 0 | 100 |
| A9 | 0.5 | 0 | 0 | 0.5 | 0 | 100 |
| A10 | 0.5 | 0 | 0 | 0.5 | 10 | 98 |
| A11 | 0.5 | 0.5 | 0 | 0.5 | 0 | 101 |
| A12 | 0.5 | 0.5 | 0 | 0.5 | 10 | 101 |
| A13 | 0.5 | 0.5 | 2 | 0.5 | 0 | 100 |

As is clear from the results in Table 1, Batteries A1 to A7, in which the positive electrode active material contains the lithium-nickel-cobalt-manganese composite oxide, a group 5/6 element, and lithium phosphate and the nonaqueous electrolyte contains DME, are remarkably excellent in room-temperature regeneration as compared to Batteries A8 to A13.

This can be explained as below. DME produces movable decomposition products by oxidative decomposition on a surface of a positive electrode during charge. When a group 5/6 element is present in or on the positive electrode, the group 5/6 element is dissolved in a nonaqueous electrolyte. The decomposition products of DME and the group 5/6 element are mixed to form a coating on a surface of a negative electrode. In this course, when both of the group 5/6 element and a phosphoric acid compound are present in or on the positive electrode, a dissolution and precipitation mode of the group 5/6 element vary and a low-resistance coating is formed on the negative electrode surface. This probably enables room-temperature regeneration to be significantly improved.

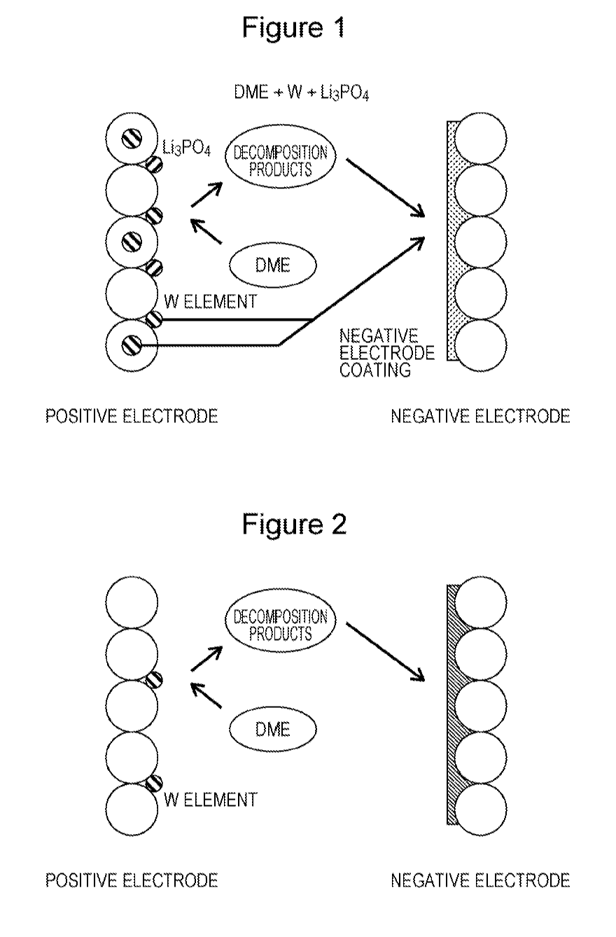

FIG. 1 is a schematic view illustrating reactions on a positive electrode and negative electrode in a nonaqueous electrolyte secondary battery according to the present disclosure. It is conceivable that DME is decomposed on a surface of the positive electrode to produce movable decomposition products and the decomposition products and a group 5/6 element dissolved from the positive electrode form a low-resistance coating on a surface of the negative electrode.

FIG. 2 is a schematic view illustrating reactions on a positive electrode and negative electrode in a conventional technique in which no phosphoric acid compound is present in or on a positive electrode. Since no phosphoric acid compound is present in or on the positive electrode, the dissolution of a group 5/6 element is not adjusted by any phosphoric acid compound. Therefore, even though a nonaqueous electrolyte contains DME, no low-resistance negative electrode coating is formed. This results in that room-temperature regeneration decreases or hardly varies as compared to the case where no DME is present, though the nonaqueous electrolyte contains DME (Batteries A9 to A12).

In the case where, even though both of a group 5/6 element and a phosphoric acid compound are present in or on a positive electrode, a nonaqueous electrolyte contains no DME (Batteries A8 and A13), the dissolution of the group 5/6 element is accelerated by the phosphoric acid compound and no decomposition products derived from DME are formed. Therefore, no low-resistance coating is formed on a surface of a negative electrode or no improvement in room-temperature regeneration is obtained.

As is clear from comparisons between Battery A2 and Batteries A6 and A7, using a positive electrode active material in which a group 5/6 element is present in a lithium transition metal oxide in the form of a solid solution and the group 5/6 element is attached to the surface of the lithium transition metal oxide enables room-temperature regeneration to be significantly improved. This is probably because a lower-resistance coating is formed on a negative electrode.

On the other hand, it can be confirmed that Batteries A1 to A7 according to the present disclosure can be improved in room-temperature regeneration and the effect of improving room-temperature regeneration is more remarkable in Batteries A1 to A4, in which the content of DME is 5% by volume to 20% by volume with respect to the amount of a solvent contained in a nonaqueous electrolyte. This is probably because, when the content of DME is within the above range, the cointegration of DME in a negative electrode can be suppressed and battery characteristics can be improved.

It is confirmed that when a positive electrode contains a lithium transition metal oxide, a group 5/6 element, and a phosphoric acid compound and a nonaqueous electrolyte contains 1,2-dimethoxyethane, the room-temperature regeneration of a nonaqueous electrolyte secondary battery can be improved.

Embodiments of the present disclosure have been described above. The present disclosure is not limited to the embodiments. Various modifications can be made within the scope of the technical spirit of the present disclosure.

### INDUSTRIAL APPLICABILITY

The present disclosure can be applied to a nonaqueous electrolyte secondary battery.

1. A nonaqueous electrolyte secondary battery comprising an electrode assembly having a structure in which a positive plate and a negative plate are stacked with a separator therebetween and a nonaqueous electrolyte,
wherein the positive plate contains a lithium transition metal oxide, an element belonging to the group 5 or 6 of the periodic table, and a phosphoric acid compound and
the nonaqueous electrolyte contains 1,2-dimethoxyethane.

2. The nonaqueous electrolyte secondary battery according to claim 1, wherein the element belonging to the group 5 or 6 of the periodic table is contained in the lithium transition metal oxide as a transition metal.

3. The nonaqueous electrolyte secondary battery according to claim 1, wherein the lithium transition metal oxide and the element belonging to the group 5 or 6 of the periodic table form a solid solution and the element belonging to the group 5 or 6 of the periodic table is attached to the surface of the lithium transition metal oxide.

4. The nonaqueous electrolyte secondary battery according to claim 1, wherein the element belonging to the group 5 or 6 of the periodic table is tungsten.

5. The nonaqueous electrolyte secondary battery according to claim 1, wherein the phosphoric acid compound is lithium phosphate.

6. The nonaqueous electrolyte secondary battery according to claim 1, wherein the content of the 1,2-dimethoxyethane is 3% by volume to 20% by volume with respect to the amount of a solvent contained in the nonaqueous electrolyte.

7. The nonaqueous electrolyte secondary battery according to claim 1, wherein the lithium transition metal oxide contains zirconium.

8. The nonaqueous electrolyte secondary battery according to claim 1, wherein the nonaqueous electrolyte contains Li(B(C₂O₄)₂).

9. A nonaqueous electrolyte secondary battery comprising an electrode assembly having a structure in which a positive plate and a negative plate are stacked with a separator therebetween and a nonaqueous electrolyte,
wherein the positive plate contains a lithium transition metal oxide, tungsten as an element belonging to the group 5 or 6 of the periodic table, and lithium phosphate as a phosphoric acid compound and
the nonaqueous electrolyte contains 1,2-dimethoxyethane;
wherein the tungsten is contained in the lithium transition metal oxide as a transition metal;
wherein the lithium transition metal oxide and the tungsten form a solid solution and the tungsten is attached to the surface of the lithium transition metal oxide;
wherein the content of the 1,2-dimethoxyethane is 3% by volume to 20% by volume with respect to the amount of a solvent contained in the nonaqueous electrolyte;
wherein the lithium transition metal oxide contains zirconium; and
wherein the nonaqueous electrolyte contains Li(B(C₂O₄)₂).
